(19) United States
(12) Patent Application Publication
(10) Pub. No.: US 2026/0145939 A1
(43) Pub. Date: May 28, 2026

(54) APPARATUS FOR EXTRACTING AND UTILIZING NOBLE GASES FROM CARBONATE ROCK

(71) Applicant: Northwest Institute of Eco-Environment and Resources, CAS, Lanzhou (CN)

(72) Inventors: Chunhui CAO, Lanzhou (CN); Liwu LI, Lanzhou (CN); Zhe DING, Lanzhou (CN); Zhongping LI, Lanzhou (CN); Xiangxian MA, Lanzhou (CN); Lantian XING, Lanzhou (CN); Yan LIU, Lanzhou (CN)

(21) Appl. No.: 19/397,865

(22) Filed: Nov. 22, 2025

(30) Foreign Application Priority Data
Nov. 28, 2024 (CN) 2024117238735

(51) Int. Cl. C01B 23/00; B02C 23/08

(52) U.S. Cl. CPC C01B 23/0036; B02C 23/08

(57) ABSTRACT

An apparatus for extracting and utilizing noble gases from carbonate rock includes a container body. A gas-solid separation assembly defines filter pores, and a diameter of each filter pore is micrometer-scale. A mechanical crushing assembly is disposed at a bottom of the gas-solid separation assembly, and is configured to crush a carbonate-rock sample until particles each have a size on the order of micrometers or larger. The gas-solid separation assembly is elastic. The particle deposition device is disposed inside a crushing chamber. The particle deposition device includes connecting ropes and spheres. The connecting ropes are fixed to an inner wall of the crushing chamber, and the spheres are fixed to the connecting ropes. This apparatus not only avoids the generation of large quantities of impurity components, but also separates solid carbonate-rock sample particles from the noble gases, enabling effective extraction of the noble gases from the carbonate-rock sample for utilization.

### CROSS-REFERENCE TO RELATED APPLICATION

This application claims priority to Chinese Patent Application No.202411723873.5, filed on Nov. 28, 2024, which is herein incorporated by reference in its entirety.

### TECHNICAL FIELD

The disclosure relates to the technical field of noble gas extraction and utilization equipment, and more particularly to an apparatus for extracting and utilizing noble gases from carbonate rock.

### BACKGROUND

Noble gases, including helium (He), neon (Ne), argon (Ar), krypton (Kr), and xenon (Xe), serve as a group of inert geochemical tracers. Original compositions of the noble gases are independent of microbial activity, chemical reactions, or variations in oxygen fugacity. Moreover, in geological samples, such as rocks, groundwater, and natural gas, concentrations of the noble gases are extremely low. However, the noble gases exhibit high sensitivity, enabling them to trace minute changes in geological fluids during complex geological processes. In addition, the noble gases in subsurface fluids primarily originate from three sources: the atmosphere, the crust, and the mantle. The noble gases from these sources have distinct elemental and isotopic compositions, making them effective tracers for identifying origins of materials. Noble gas geochemistry has been applied to various fields of Earth sciences, including crust-mantle material exchange, volcanic and seismic activities, petroleum and natural gas resources, fluid-rock interactions and mineral resources, mantle-derived rocks and mantle degassing, subduction zones and serpentinization, paleoclimate and environmental evolution, geological storage of carbon dioxide, groundwater pollution tracing, and many other fields of Earth science research.

Currently, noble gas isotope analysis platforms are capable of analyzing solid samples, but most of them are based on a principle of a high-temperature melting method. This approach is evidenced by research findings from references such as “Zhang Wen. Accumulation Mechanism of Helium, a Strategic Resource, in Guanzhong and Northern Qaidam Basin [D]. China University of Mining and Technology-Beijing, 2019” and “Wang Ying, He Huaiyu, Zhang Chuantong, et al. Method of determining noble gases in trace meteorite specimens using a laser microprobe [J]. Acta Petrologica Sinica, 2018, 34(11)”.

However, carbonate-rock samples are not suitable for analysis by the high-temperature melting method. When using the high-temperature melting method, the carbonate-rock samples release large quantities of volatile components, such as carbon dioxide (CO₂), hydrogen sulfide (H₂S), and organic matter. These volatile components often exceed purification capacity of instrumentation and cannot be completely removed. In addition, a proportion of the noble gases in the carbonate-rock samples may only be a few percent or even lower, which can significantly affect analysis results of the noble gases.

### SUMMARY

To solve the above technical solutions, the disclosure provides an apparatus for extracting and utilizing noble gases from carbonate rock.

A purpose of the disclosure is to provide an apparatus for extracting and utilizing noble gases from carbonate rock, which includes a container body. A gas-solid separation assembly is disposed in the container body, and the gas-solid separation assembly defines filter pores. A diameter of each of the filter pores is micrometer-scale, and the filter pores are configured to allow passage of the noble gases and to block carbonate-rock sample particles. The gas-solid separation assembly divides the container body into an upper chamber and a lower chamber, and the upper chamber is configured to be connected to noble gas purification and detection equipment. A mechanical crushing assembly is disposed at a bottom of the gas-solid separation assembly, and the mechanical crushing assembly is configured to mechanically crush a carbonate-rock sample to obtain the carbonate-rock sample particles. A particle size of each of the carbonate-rock sample particles is greater than the diameter of each of the filter pores.

The gas-solid separation assembly is elastic. The mechanical crushing assembly includes a motor, a crushing component, and a crushing chamber. The crushing chamber is connected to the bottom of the gas-solid separation assembly, and the motor is disposed inside the crushing chamber.

A particle deposition device is disposed inside the crushing chamber, and the particle deposition device is disposed above the motor and the crushing component. The particle deposition device includes connecting ropes and spheres. The connecting ropes are connected to an inner wall of the crushing chamber, and the spheres are connected to the connecting ropes.

In an embodiment, the crushing component is a crushing blade.

In an embodiment, in the apparatus for extracting and utilizing the noble gases from carbonate rock, deposition components are disposed on each of the spheres, and a diameter of each of the deposition components is micrometer-scale or centimeter-scale. The deposition components are spherical or hemispherical.

In an embodiment, in the apparatus for extracting and utilizing the noble gases from carbonate rock, the deposition components are disposed on an upper half of each of the spheres, and a lower half of each of the sphere has a smooth surface.

In an embodiment, in the apparatus for extracting and utilizing the noble gases from carbonate rock, the deposition components are deposition holes, and a diameter of each of the deposition holes is centimeter-scale; or the deposition components are protrusions, and a diameter of each of the protrusions is micrometer-scale.

In an embodiment, in the apparatus for extracting and utilizing the noble gases from carbonate rock, the diameter of each of the filter pores is in a range of 1 micrometer (μm) to 800 μm; the diameter of each of the deposition holes is in a range of 1 centimeter (cm) to 2 cm; and the diameter of each of the protrusions is in a range of 1 μm to 10 μm.

In an embodiment, in the apparatus for extracting and utilizing the noble gases from carbonate rock, the particle deposition device includes at least two layers, and spheres in every adjacent two of the at least two layers are arranged in a staggered configuration. That's to say, a number of the connecting ropes is at least two, and spheres in every adjacent two of the at least two connecting ropes are arranged in a staggered configuration.

In an embodiment, in the apparatus for extracting and utilizing the noble gases from carbonate rock, the spheres in every adjacent two of the at least two layers are in contact with each other, that is, when spheres of two adjacent layers are staggered, each sphere in one of the two adjacent layers is in contact with two spheres in another layer adjacent to the sphere in the one of the two adjacent layers.

In an embodiment, in the apparatus for extracting and utilizing the noble gases from carbonate rock, an elastic layer is disposed between the crushing chamber and an inner wall of the container body.

In an embodiment, in the apparatus for extracting and utilizing the noble gases from carbonate rock, the gas-solid separation assembly includes a fixed portion and a gas-permeable portion. The gas-permeable portion is disposed at a center of the fixed portion, and the gas-permeable portion defines the filter pores. The fixed portion is connected to the inner wall of the container body.

The crushing chamber is disposed at a bottom of the gas-permeable portion. An edge of the crushing chamber is connected to a corresponding edge of the gas-permeable portion via a connecting plate. A junction between the fixed portion and the gas-permeable portion is flush with a corresponding outer edge of the connecting plate.

Compared with the related art, the disclosure may achieve the following beneficial effects.

In the apparatus for extracting and utilizing the noble gases from carbon rock of the disclosure, the container body serves as a main structure. The mechanical crushing assembly is configured to mechanically crush the carbonate-rock sample to release the noble gases. The released noble gases flow from the lower chamber into the upper chamber through the filter pores for subsequent utilization. During mechanical crushing of the carbonate-rock sample, mechanical vibration generated by the motor is transmitted to the crushing chamber and the gas-solid separation assembly in sequence, dislodging carbonate-rock sample particles adhering to the gas-solid separation assembly, thereby allowing the noble gases to pass while preventing clogging of the gas-solid separation assembly. In addition, the particle deposition device is configured to deposit the carbonate-rock sample particles. This addresses a technical problem that when the mechanical crushing assembly initially crushes the carbonate-rock sample, the generated carbonate-rock sample particles become airborne and occupy space within the lower chamber, which would otherwise hinder diffusion of the noble gases toward the upper chamber. By providing the particle deposition device, excessive dispersion of the carbonate-rock sample particles is effectively restrained.

The above structure not only avoids the generation of large quantities of impurity components such as CO₂, H₂S, and organic matter through a high-temperature melting method, but also effectively separates the solid carbonate-rock sample particles from the noble gases. This enables efficient extraction of the noble gases from the carbonate-rock sample, making the noble gases available for effective utilization without interference from impurity gases, while simultaneously preventing severe contamination of an entire noble gas isotope analysis platform.

### BRIEF DESCRIPTION OF DRAWINGS

FIG. 1 illustrates a schematic diagram of an apparatus for extracting and utilizing noble gases from carbonate rock according to an embodiment 1 of the disclosure.

FIG. 2 illustrates a top view of a gas-solid separation assembly according to the embodiment 1 of the disclosure.

FIG. 3 illustrates a schematic partial structural diagram of a particle deposition device according to the embodiment 1 of the disclosure.

FIG. 4 illustrates a top view of the particle deposition device according to the embodiment 1 of the disclosure.

FIG. 5 illustrates a schematic partial structural diagram of a particle deposition device according to an embodiment 2 of the disclosure.

FIG. 6 illustrates a schematic diagram of an apparatus for extracting and utilizing noble gases from carbonate rock according to an embodiment 3 of the disclosure.

FIG. 7 illustrates a schematic structural diagram of noble gas purification and detection equipment.

### DETAILED DESCRIPTION OF EMBODIMENTS

To enable those skilled in the art to better understand and implement technical solutions of the disclosure, the following further description of the disclosure is provided in conjunction with specific embodiments and attached drawings.

In the description of the disclosure, unless otherwise specified, all reagents used are commercially available, and all methods used are conventional techniques in the art.

In the description of the disclosure, it should be understood that terms such as “center”, “longitudinal”, “transverse”, “length”, ‘width”, “thickness” “up”, “below”, “front”, “rear”, “left”, “right”, “vertical”, “horizontal”, “top”, “bottom”, “inside”, “outside”, “clockwise”, “counterclockwise”, “axial”, “radial” and “circumferential” are indicative of orientation or positional relationships based on orientation or positional relationships shown in the attached drawings, and are used solely for the convenience of describing the disclosure and simplifying the description, rather than to indicate or suggest that devices or components referred to must have a specific orientation or be constructed and operated in a specific orientation. Therefore, these terms should not be construed as limitations of the disclosure.

Terms “first′ and “second” are used for descriptive purposes only and cannot be understood as indicating or implying any relative importance or suggesting a number of technical features referred to. Consequently, features specified as “first” or ‘second” may explicitly or implicitly encompass one or more such features. In the description of the disclosure, unless otherwise specified, the meaning of “multiple” refers to two or more.

Carbonate-rock samples are not suitable for analysis by a high-temperature melting method. When using the high-temperature melting method, the carbonate-rock samples release large quantities of volatile components, such as CO₂, H₂S, and organic matter. These volatile components often exceed purification capacity of instrumentation and cannot be completely removed. In addition, a proportion of noble gases in the carbonate-rock samples may only be a few percent, which seriously affects analysis results of the noble gases and leads to low utilization rate of the carbonate-rock samples, and even causes serious pollution to an entire noble gas isotope analysis platform.

Based on the above reasons, the disclosure designs an apparatus for extracting and utilizing noble gases from carbonate rock by using the following principle. Molecular diameters of the noble gases are essentially nanometer-scale. For example, a molecular diameter of He is approximately 0.218 nanometers (nm), a molecular diameter of Ar is approximately 0.34 nm, a molecular diameter of Kr is approximately 0.6 nm, and a molecular diameter of Xe is approximately 0.22 nm. In contrast, a particle size of each of carbonate-rock sample particles obtained by mechanical crushing can be controlled on the order of micrometers or larger.

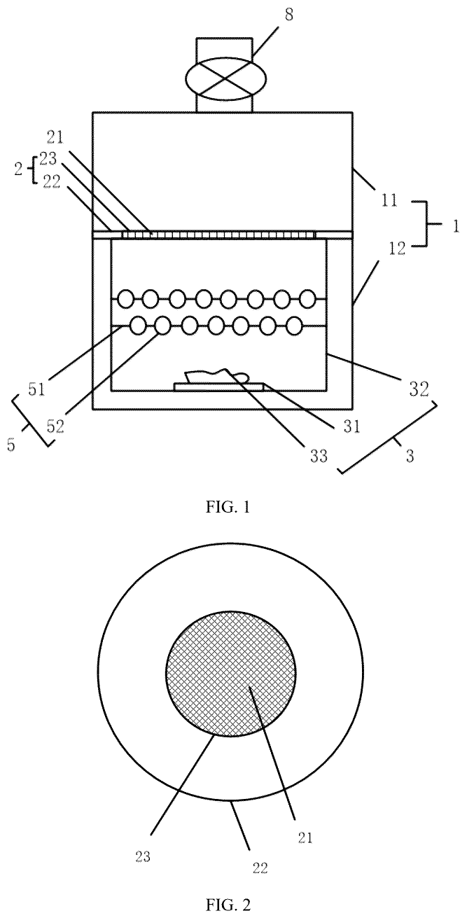

In the disclosure, an apparatus for extracting and utilizing noble gases from carbonate rock, referring to FIG. 1, includes a container body 1. The container body 1 is a sealed vessel and is configured to be connected to noble gas purification and detection equipment via a conduit 8. A gas-solid separation assembly 2 and a mechanical crushing assembly 3 are disposed in the container body 1. The gas-solid separation assembly 2 defines filter pores 21. A diameter of each filter pore 21 is micrometer-scale, and the filter pores 21 are configured to allow passage of the noble gases and to block the carbonate-rock sample particles obtained by mechanical crushing. The gas-solid separation assembly 2 divides the container body 1 into an upper chamber 11 and a lower chamber 12. Specifically, the upper chamber 11 is connected to the noble gas purification and detection equipment via the conduit 8. The mechanical crushing assembly 3 is disposed at a bottom of the gas-solid separation assembly 2, and the mechanical crushing assembly 3 is configured to crush a carbonate-rock sample such that the resulting carbonate-rock sample particles each has a particle size on the order of micrometers or larger. After mechanical crushing, the noble gases within the carbonate-rock sample are fully released. Based on a principle of free diffusion of gases, the noble gases diffuse through the filter pores 21 of the gas-solid separation assembly 2 into the upper chamber 11. In contrast, the resulting solid carbonate-rock sample particles remain within the lower chamber 12 due to the blocking effect of the gas-solid separation assembly 2. The gas-solid separation assembly 2 is elastic. Consequently, during mechanical crushing of the carbonate-rock sample, mechanical vibration induces vibration in the gas-solid separation assembly 2. This vibration dislodges carbonate-rock sample particles adhering to the gas-solid separation assembly 2, thereby allowing the noble gases to pass while preventing clogging of the gas-solid separation assembly 2.

In addition, the mechanical crushing assembly 3 includes a motor 31, a crushing component, and a crushing chamber 32. The crushing chamber 32 is connected to the bottom of the gas-solid separation assembly 2, and the motor 31 is disposed inside the crushing chamber 32. A particle deposition device 5 is disposed inside the crushing chamber 32, and the particle deposition device 5 is disposed above the motor 31 and the crushing component. The particle deposition device 5 includes connecting ropes 51 and spheres 52. The connecting ropes 51 are connected to an inner wall of the crushing chamber 32, and the spheres 52 are connected to the connecting ropes 51. This arrangement addresses a technical problem that when the mechanical crushing assembly 3 initially crushes the carbonate-rock sample, the generated carbonate-rock sample particles become airborne and occupy space within the lower chamber 12, which would otherwise hinder diffusion of the noble gases toward the upper chamber 11. By providing the particle deposition device 5, excessive dispersion of the carbonate-rock sample particles is effectively restrained.

The apparatus for extracting and utilizing the noble gases for carbonate rock provided by the disclosure not only avoids the generation of large quantities of impurity components such as CO₂, H₂S, and organic matter through the high-temperature melting method, but also effectively separates the solid carbonate-rock sample particles from the noble gases. This enables efficient extraction of the noble gases from the carbonate-rock sample, making the noble gases available for effective utilization without interference from impurity gases, while simultaneously preventing severe contamination of the entire noble gas isotope analysis platform.

A specific structure and a working principle of the apparatus for extracting and utilizing the noble gases from carbonate rock of the disclosure are illustrated through the following embodiments.

### Embodiment 1

An apparatus for extracting and utilizing noble gases from carbon rock, referring to FIG. 1, includes a container body 1. The container body 1 is a sealed vessel and is configured to be connected to noble gas purification and detection equipment. The container body 1 may be cylindrical or cubic in shape. Specifically, the container body 1 is made of a vacuum-compatible material to facilitate vacuum operations performed by the noble gas purification and detection equipment.

A gas-solid separation assembly 2 is disposed in the container body 1, and the gas-solid separation assembly 2 divides the container body 1 into an upper chamber 11 and a lower chamber 12. The gas-solid separation assembly 2 defines multiple filter pores 21, and a diameter of each filter pore 21 is micrometer-scale. The filter pores 21 are configured to allow passage of the noble gases and to block carbonate-rock sample particles obtained by mechanical crushing. In the embodiment, a number of the filter pores 21 is at least 50, specifically is 50 to 1,000. The diameter of each filter pore 21 may be any value within a range of 1 μm to 800 μm. All such diameter values are greater than molecular diameters of the noble gases such as He, Ne, Ar, Kr, and Xe, thereby allowing the passage of the noble gases. In contrast, conventional mechanical crushing methods can process a carbonate-rock sample into the carbonate-rock sample particles each having a particle size greater than the diameter of each filter pore 21. For example, the particle size of each carbonate-rock sample particle may be any value within a range of 900 μm to 500 millimeters (mm).

The gas-solid separation assembly 2 is elastic, such that during mechanical crushing of the carbonate rock sample, the mechanical vibration induces vibration in the gas-solid separation assembly 2. This vibration dislodges carbonate-rock sample particles adhering to the gas-solid separation assembly 2, thereby allowing the noble gases to pass while preventing clogging of the gas-solid separation assembly 2.

Furthermore, in the present embodiment, as shown in FIG. 2, a cross-sectional shape and an area thereof of the gas-solid separation assembly 2 are equal to those of the container body 1, so that the gas-solid separation assembly 2 completely blocks the container body 1, and the upper chamber 11 and the lower chamber 12 are connected only through the filter pores 21, thereby preventing the carbonate-rock sample particles from dispersing into the upper chamber 11 via any other path.

To provide improved load-bearing capacity, the gas-solid separation assembly 2 includes a fixed portion 22 and a gas-permeable portion 23. The gas-permeable portion 23 defines the filter pores 21. The fixed portion 22 is fixedly connected to an inner wall of the container body 1, and a bottom of the fixed portion 22 is configured to be connected to a crushing chamber 32. The gas-permeable portion 23 is disposed at a center of the fixed portion 22.

To maximize collection of the noble gases, the crushing chamber 32 surrounds the gas-permeable portion 23. For example, the fixed portion 22 is configured as an annular ring, and the gas-permeable portion 23 is configured as a circular disc. An outer edge of the fixed portion 22 is fixedly connected to the inner wall of the container body 1, and an inner edge of the fixed portion 22 is fixedly connected to a corresponding outer edge of the gas-permeable portion 23, and a junction between the fixed portion 22 and the gas-permeable portion 23 is sealed with a sealant or a sealing gasket.

A mechanical crushing assembly 3 is disposed inside the lower chamber 12. The mechanical crushing assembly 3 is disposed below the gas-solid separation assembly 3, and the bottom of the fixed portion 22 is connected to the mechanical crushing assembly 3. The mechanical crushing assembly 3 is configured to crush the carbonate-rock sample such that the resulting carbonate-rock sample particles each has the particle size on the order of micrometers or larger. Furthermore, the mechanical crushing assembly 3 can use crushing equipment selected from the group consisting of electromagnetic crushing equipment, blade crushing equipment, hammer crushing equipment, cone crushing equipment, and impact crushing equipment. In essence, any crushing equipment adapted to crush the carbonate-rock sample into particles each having the particle size on the order of micrometers or larger is applicable to the disclosure.

By way of example, the mechanical crushing assembly 3 includes a motor 31, a crushing component, and the crushing chamber 32. The crushing chamber 32 is connected to the bottom of the fixed portion 22. The motor 31 is disposed inside the crushing chamber 32. The crushing component is a crushing blade 33, and the crushing blade 33 is disposed on the motor 31. The crushing blade 33 is configured to crush the carbonate-rock sample. After crushing, the noble gases within the carbonate-rock sample are fully released. Based on a principle of free diffusion of gases, the noble gases diffuse through the gas-solid separation assembly 2 into the upper chamber 11. In contrast, the resulting solid carbonate-rock sample particles remain within the lower chamber 12 due to the blocking effect of the gas-solid separation assembly 2.

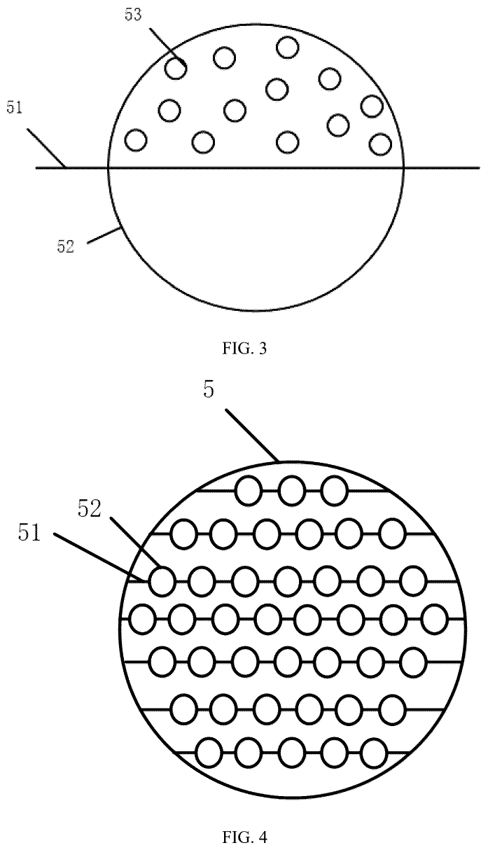

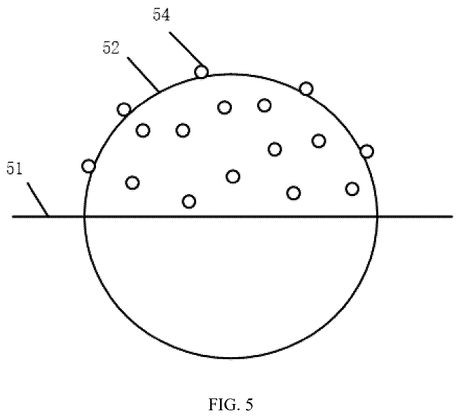

In addition, as shown in FIGS. 3 and 4, in the present embodiment, a particle deposition device 5 is disposed inside the crushing chamber 32, and the particle deposition device 5 is disposed above the motor 31 and the crushing component. The particle deposition device 5 is configured to deposit the carbonate-rock sample particles.

Furthermore, the particle deposition device includes connecting ropes 51 and spheres 52. The connecting ropes 51 are fixed to the inner wall of the crushing chamber 32, and the spheres 52 are fixedly threaded through the connecting ropes 51. Deposition components are disposed on each sphere 52, and a diameter of each deposition component is micrometer-scale or centimeter-scale.

Specifically, the deposition components are deposition holes 53, and a diameter of each deposition hole 53 is centimeter-scale, for example, is in a range of 1 cm to 2 cm. the diameter of each deposition hole 53 is substantially greater than the particle size of each carbonate-rock sample particle and the molecular diameters of the noble gases. These deposition holes 53 are configured to capture the carbonate-rock sample particles falling under gravity.

Furthermore, the deposition holes 53 are disposed only in an upper half of each sphere 52 and are hemispherical. Because the volatilized noble gases diffuse upward into the upper chamber 11, a lower half of each sphere 52 has a smooth surface to minimize resistance to the passage of the noble gases. The carbonate-rock sample particles, moving downward under gravity, are captured and accumulate in the deposition holes 53, thereby reducing interference between the carbonate-rock sample particles and the movement of the noble gases.

Furthermore, the particle deposition device 5 includes at least two layers with the spheres 52 arranged in a staggered configuration. Surfaces of the spheres 52 in adjacent layers are in contact with each other. This arrangement enables mutual vibration transmission between the spheres 52 of adjacent layers during operation. When vibration ceases, multiple layers of spheres 52 form a thick network for intercepting the carbonate-rock sample particles, thereby capturing larger-sized carbonate-rock sample particles and preventing their deposition at the bottom of the crushing chamber 32. In contrast, the noble gases owing to their small molecular diameters, can readily pass through this thick network.

The particle deposition device 5 further offers the following advantages. The motor 31 operates intermittently, and during active crushing, the vibration induces vibration in the particle deposition device 5, thereby assisting in crushing the carbonate-rock sample. During pauses in mechanical crushing, the already crushed carbonate-rock sample particles deposit on the particle deposition device 5, preventing them from settling at the bottom of the crushing chamber 32. Consequently, the noble gases contained within both the carbonate-rock sample particles at the bottom of the crushing chamber 32 and those deposited on the particle deposition device 5 can diffuse toward the upper chamber 11. This configuration increases an available diffusion surface area and enhances an overall diffusion efficiency.

The above structure not only avoids the generation of large quantities of impurity components such as CO₂, H₂S, and organic matter through a high-temperature melting method, but also effectively separates the solid carbonate-rock sample particles from the noble gases. This enables efficient extraction of the noble gases from the carbonate-rock sample, making the noble gases available for effective utilization without interference from impurity gases, while simultaneously preventing severe contamination of an entire noble gas isotope analysis platform.

### Embodiment 2

An apparatus for extracting and utilizing noble gases from carbonate rock has a structure substantially the same as that of the embodiment 1. Specifically, the apparatus for extracting and utilizing the noble gases from carbonate rock of this embodiment includes a container body 1. A gas-solid separation assembly 2 is disposed in the container body 1, and the gas-solid separation assembly 2 defines filter pores 21. A diameter of each filter pores 21 is micrometer-scale, and the filter pores 21 are configured to allow passage of the noble gases and to block carbonate-rock sample particles. The gas-solid separation assembly 2 divides the container body 1 into an upper chamber 11 and a lower chamber 12. A mechanical crushing assembly 3 is disposed at a bottom of the gas-solid separation assembly 2, and the mechanical crushing assembly 3 is configured to mechanically crush a carbonate-rock sample to obtain the carbonate-rock sample particles. A particle size of each carbon-rock sample particle is greater than the diameter of each filter pores 21. The gas-solid separation assembly 2 is elastic. The mechanical crushing assembly 2 includes a motor 31, a crushing component, and a crushing chamber 32. The crushing chamber 32 is connected to the bottom of the gas-solid separation assembly 2, and the motor 31 is disposed inside the crushing chamber 32. A particle deposition device 5 is disposed inside the crushing chamber 32, and the particle deposition device 5 is disposed above the motor 31 and the crushing component. The particle deposition device 5 includes connecting ropes 51 and the spheres 52. The connecting ropes 51 are connected to an inner wall of the crushing chamber 32, and the spheres 52 are connected to the connecting ropes 51.

The present embodiment differs from the embodiment 1 in that, protrusions 54 are disposed on each sphere 52, as shown in FIG. 5. A diameter of each protrusion 54 is micrometer-scale, e.g., 1 μm to 10 μm. Serving as nucleation sites, the protrusions 54 are capable of aggregating the carbonate-rock sample particles, thereby facilitating deposition of the carbonate-rock sample particles on each sphere 52.

### Embodiment 3

An apparatus for extracting and utilizing noble gases from carbonate rock has a structure substantially the same as that of the embodiment 1. Specifically, the apparatus for extracting and utilizing the noble gases from carbonate rock of this embodiment includes a container body 1. A gas-solid separation assembly 2 is disposed in the container body 1, and the gas-solid separation assembly 2 defines filter pores 21. A diameter of each filter pores 21 is micrometer-scale, and the filter pores 21 are configured to allow passage of the noble gases and to block carbonate-rock sample particles. The gas-solid separation assembly 2 divides the container body 1 into an upper chamber 11 and a lower chamber 12. A mechanical crushing assembly 3 is disposed at a bottom of the gas-solid separation assembly 2, and the mechanical crushing assembly 3 is configured to mechanically crush a carbonate-rock sample to obtain the carbonate-rock sample particles. A particle size of each carbon-rock sample particle is greater than the diameter of each filter pores 21. The gas-solid separation assembly 2 is elastic. The mechanical crushing assembly 2 includes a motor 31, a crushing component, and a crushing chamber 32. The crushing chamber 32 is connected to the bottom of the gas-solid separation assembly 2, and the motor 31 is disposed inside the crushing chamber 32. A particle deposition device 5 is disposed inside the crushing chamber 32, and the particle deposition device 5 is disposed above the motor 31 and the crushing component. The particle deposition device 5 includes connecting ropes 51 and the spheres 52. The connecting ropes 51 are connected to an inner wall of the crushing chamber 32, and the spheres 52 are connected to the connecting ropes 51.

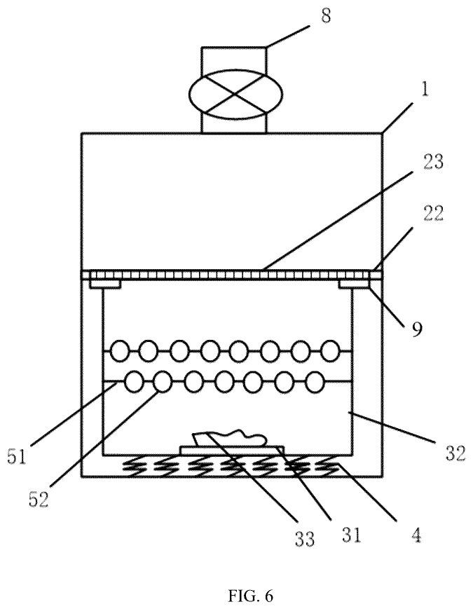

The present embodiment differs from the embodiment 1 in that, as shown in FIG. 6, an elastic layer 4 is disposed between the mechanical crushing assembly 3 and an inner wall of the container body 1 so as to enhance the mechanical vibration of the crushing assembly 3 while also supporting load, thereby better preventing the gas-solid separation assembly 2 from blocking. The elastic layer 4 is a spring or an elastic rubber layer and functions to support load and transmit vibration.

Moreover, the present embodiment differs from the embodiment 1 in that, the crushing chamber 32 is connected to connecting plates 9, and the crushing chamber 32 and the connecting plates 9 are assembled together to surround the gas-permeable portion 23. Specifically, a top edge of the crushing chamber 32 is detachably or fixedly connected to a lower surface of a corresponding one of the connecting plates 9. An upper surface of the connecting plate 9 is fixedly connected to a corresponding junction between the fixed portion 22 and the gas-permeable portion 23. This arrangement achieves a connection between the edge of the crushing chamber 32 and the edge of the gas permeable portion 23 through the connecting plate 9. In addition, the junction between the fixed portion 22 and the gas-permeable portion 23 is flush with a corresponding outer edge of the connecting plate 9.

More specifically, the crushing chamber 32 is disposed at a bottom of a gas-permeable portion 23, and an edge of the crushing chamber 32 is connected to a corresponding edge of the gas-permeable portion 23 via the connecting plate 9. A junction between a fixed portion 22 and the gas-permeable portion 23 is flush with a corresponding outer edge of the connecting plate 9 to minimize gas leakage. The elastic layer 4 is disposed between the crushing chamber 32 and the inner wall of the container body 1. The elastic effect of the elastic layer 4and the gas-permeable portion 23 cooperates with the vibration effect of the mechanical crushing assembly 3 to enhance the overall vibration effect.

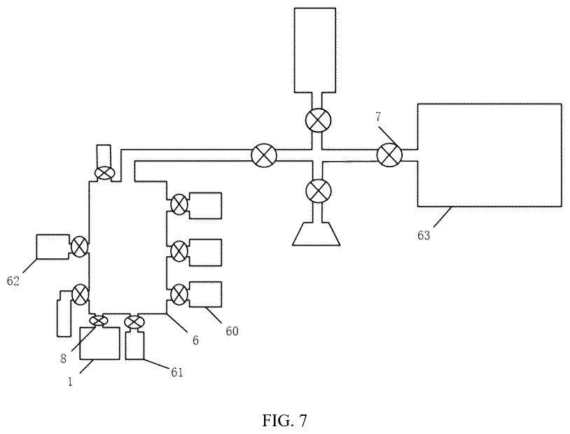

To further illustrate a use scenario of the disclosure, referring to FIG. 7, noble gas purification and detection equipment connected to the apparatus for extracting and utilizing the noble gases from carbonate rock is provided. This equipment includes a detection chamber 6, which is connected to components including an activated carbon trap 60, a vacuum pump 61, a quadrupole mass spectrometer 62, and a noble gas isotope spectrometer 63. Each of these components is connected to the detection chamber 6 via a conduit 8, and a valve 7 is disposed on the conduit 8. The noble gases extracted by the apparatus for extracting and utilizing the noble gases from carbonate rock can be introduced into the detection chamber 6, and analyzed directly by the quadrupole mass spectrometer 62 or the noble gas isotope spectrometer 63, or first purified by the activated carbon trap 60 and subsequently analyzed.

It should be noted that connection relationships of components not specifically mentioned in the disclosure are assumed to be based on the related art. Since these do not involve inventive aspects and are commonly applied in the related aet, structural connection relationships will not be described in detail.

It should be noted that when the disclosure involves numerical ranges, it should be understood that two endpoints of each numerical range and any value between the two endpoints can be selected. Since methods and steps adopted are the same as those in embodiments, in order to avoid repetition, the disclosure describes the specific embodiments. Although the specific embodiments of the disclosure have been described, once those skilled in the art have understood the basic inventive concept, they can make additional changes and modifications to these specific embodiments, and these changes and modifications all fall within the scope of the disclosure.

It is apparent that those skilled in the art can make various modifications and variations to the disclosure without departing from the spirit and scope of the disclosure. If these modifications and variations fall within the scope of equivalent technology of the disclosure, the disclosure is also intended to include such modifications and variations.

What is claimed is:

1. An apparatus for extracting and utilizing noble gases from carbonate rock, comprising a container body (1), wherein a gas-solid separation assembly (2) is disposed in the container body (1), the gas-solid separation assembly (2) defines filter pores (21), a diameter of each of the filter pores (21) is micrometer-scale, and the filter pores (21) are configured to allow passage of the noble gases and to block carbonate-rock sample particles; the gas-solid separation assembly (2) divides the container body (1) into an upper chamber (11) and a lower chamber (12), and the upper chamber (11) is configured to be connected to noble gas purification and detection equipment; and a mechanical crushing assembly (3) is disposed at a bottom of the gas-solid separation assembly (2), the mechanical crushing assembly (3) is configured to mechanically crush a carbonate-rock sample to obtain the carbonate-rock sample particles, and a particle size of each of the carbonate-rock sample particles is greater than the diameter of each of the filter pores (21);
wherein the gas-solid separation assembly (2) is elastic, the mechanical crushing assembly (3) comprises a motor (31), a crushing component, and a crushing chamber (32), the crushing chamber (32) is connected to the bottom of the gas-solid separation assembly (2), and the motor (31) is disposed inside the crushing chamber (32);
wherein a particle deposition device (5) is disposed inside the crushing chamber (32), and the particle deposition device (5) is disposed above the motor (31) and the crushing component; the particle deposition device (5) comprises connecting ropes (51) and spheres (52), the connecting ropes (51) are connected to an inner wall of the crushing chamber (32), and the spheres (52) are connected to the connecting ropes (51);
wherein the gas-solid separation assembly (2) comprises a fixed portion (22) and a gas-permeable portion (23), the gas-permeable portion (23) is disposed at a center of the fixed portion (22), the gas-permeable portion (23) defines the filter pores (21), and the fixed portion (22) is connected to an inner wall of the container body (1); and
wherein the crushing chamber (32) is disposed at a bottom of the gas-permeable portion (23), an edge of the crushing chamber (32) is connected to a corresponding edge of the gas-permeable portion (23) via a connecting plate (9), and a junction between the fixed portion (22) and the gas-permeable portion (23) is flush with a corresponding outer edge of the connecting plate (9).

2. The apparatus for extracting and utilizing the noble gases from carbonate rock as claimed in claim 1, wherein deposition components are disposed on each of the spheres (52), and a diameter of each of the deposition components is micrometer-scale or centimeter-scale.

3. The apparatus for extracting and utilizing the noble gases from carbonate rock as claimed in claim 2, wherein the deposition components are disposed on an upper half of each of the spheres (52), and a lower half of each of the spheres (52) has a smooth surface.

4. The apparatus for extracting and utilizing the noble gases from carbonate rock as claimed in claim 2, wherein the deposition components are deposition holes (53), and a diameter of each of the deposition holes (53) is centimeter-scale; or
wherein the deposition components are protrusions (54), and a diameter of each of the protrusions (54) is micrometer-scale.

5. The apparatus for extracting and utilizing the noble gases from carbonate rock as claimed in claim 4, wherein the diameter of each of the filter pores (21) is in a range of 1 micrometer (μm) to 800 μm; the diameter of each of the deposition holes (53) is in a range of 1 centimeter (cm) to 2 cm; and the diameter of each of the protrusions (54) is in a range of 1 μm to 10 μm.

6. The apparatus for extracting and utilizing the noble gases from carbonate rock as claimed in claim 1, wherein the particle deposition device (5) comprises at least two layers, and spheres (52) in every adjacent two of the at least two layers are arranged in a staggered configuration.

7. The apparatus for extracting and utilizing the noble gases from carbonate rock as claimed in claim 6, wherein the spheres (52) in every adjacent two of the at least two layers are in contact with each other.

8. The apparatus for extracting and utilizing the noble gases from carbonate rock as claimed in claim 1, wherein an elastic layer (4) is disposed between the crushing chamber (32) and the inner wall of the container body (1).

9. The apparatus for extracting and utilizing the noble gases from carbonate rock as claimed in claim 8, wherein the elastic layer (4) is a spring or an elastic rubber layer.
